(19) United States
(12) Patent Application Publication
(10) Pub. No.: US 2006/0243823 A1
(43) Pub. Date: Nov. 2, 2006

(54) Device which is provided for fixing in a motor vehicle and is intended for cleaning a window or a headlamp lens

(75) Inventors: Marcus Bachmann, Waldkappel (DE); Andreas Rehs, Rotenburg (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 10/566,171

(22) PCT Filed: Jul. 13, 2004
(86) PCT No.: PCT/EP04/51475

§ 371 Date: Jan. 27, 2006

(30) Foreign Application Priority Data
Aug. 27, 2003 (DE) 103 39 505.9

(51) Int. Cl. B05B 1/10

(52) U.S. Cl. 239/284.1; 239/513

(57) ABSTRACT

Disclosed is a device for cleaning a window of a motor vehicle, comprising a cleaning nozzle (9) that is mounted in a nozzle holder (4) so as to be pivotable about a horizontal axis. The nozzle holder (4) is fastened in a fixed manner to a body sheet of the motor vehicle. A specific spraying range which is to be sprinkled with cleaning liquid can be adjusted on the window when the cleaning nozzle (9) is pivoted.

The invention relates to a device which is provided for fixing in a motor vehicle and is intended for cleaning a window or a headlamp lens, having a washing nozzle retained by a nozzle holder, and having means for adjusting the angle of inclination of the washing nozzle.

Such a device is known, for example, from DE 196 52 083 A1. The washing nozzle here is installed in a fixed manner in the nozzle holder. The nozzle holder is retained in a cutout of a bodywork panel and is prestressed in relation to an adjustable stop by means of a spring element. The nozzle holder has a mounting in a region which is remote from the adjustable stop. When the stop is adjusted, it is possible to pivot the entire nozzle holder and thus to set the angle of inclination of the washing nozzle. It is therefore possible to set a washing-fluid jet of the washing nozzle following installation in a motor vehicle and thus to compensate for tolerances of the window which is to be cleaned in relation to bodywork parts which are adjacent to it. It is also possible to re-set the washing-fluid jet, for example, after the motor vehicle has been involved in an accident.

The disadvantage with the known device is that the nozzle holder has very large dimensions and requires a large cutout in a bodywork panel of the motor vehicle or has to be installed beneath the engine hood. Furthermore, the device, with the plug-in connection to the fluid line and the washing nozzle, has two sealing locations, which require special machining in order to ensure that the sealing is tight.

The invention is based on the problem of developing a device of the type mentioned in the introduction such that the nozzle holder has very small dimensions and can be inserted in the smallest possible cutout of the bodywork panel.

This problem is solved according to the invention in that the means for adjusting the angle of inclination of the washing nozzle are formed in relation to the nozzle holder.

This configuration allows the nozzle holder to be fixed in an immovable manner in the bodywork panel. Thanks to the invention, the nozzle holder does not require a mounting with large dimensions. This results in the nozzle holder having particularly small dimensions. For the purpose of fixing the nozzle holder, the bodywork panel, in the most favorable case, requires only a small cutout for a washing-fluid supply to the washing nozzle and for fixing means of the nozzle holder. The cutout in the bodywork panel may thus be formed to be particularly small in comparison with the known device. Since the nozzle holder can be installed in an immovable manner in the cutout of the bodywork panel, it is possible for the cutout, in addition, to be easily sealed. As a result, the device according to the invention is additionally suitable for fixing on a visible part of the bodywork panel of the motor vehicle.

According to an advantageous embodiment of the invention, the washing nozzle can be configured in a cost-effective manner if the washing nozzle is fixed in an insert arranged in the nozzle holder, and if the insert is retained in a rotatable manner. The washing nozzle can be fixed in the insert by means of a latching or plug-in connection.

It would be possible for the washing nozzle to project, for example, out of the nozzle holder. According to another advantageous development of the invention, however, it would be easy to shield the washing nozzle from the effects of weathering influences, e.g. relative wind, if the nozzle holder, in the region of the washing nozzle, has a large opening in comparison with a diameter of a washing-fluid jet which can be generated by the washing nozzle.

According to another advantageous development of the invention, the situation where the angle of inclination influences the spraying performance of the washing nozzle can easily be avoided if the nozzle holder has a chamber which is arranged immediately upstream of the insert or the washing nozzle, as seen in the direction of flow, and, in order to connect a washing-agent supply to the washing nozzle, is formed over the entire rotary region thereof.

According to another advantageous development of the invention, it helps to simplify installation if the nozzle holder is in mushroom form and, on the underside of its head region, has latching means which are provided for connecting it to a bodywork panel. This configuration also allows straightforward sealing of the cutout in the bodywork panel for the washing nozzle.

In an advantageous configuration, the washing nozzle may be both a point-jet nozzle and a fluidic nozzle, which is arranged in the insert.

The connection between the washing nozzle and the insert is preferably designed as a latching and plug-in connection.

Connection between the washing nozzle and the insert is avoided if the insert is designed as a washing nozzle, the insert having a cutout which generates the washing-fluid jet. In the simplest configuration, the cutout is a bore which runs perpendicularly to the longitudinal axis of the insert and, acting as a channel, generates the washing-fluid jet. The bore can be produced subsequently with low outlay. In an advantageous development of the invention, the bore is made during production of the insert, e.g. by virtue of the injection mold being formed correspondingly.

The use of a nozzle is avoided if the bore in the insert tapers downstream. The bore here can taper continuously or in a step-like manner.

If use is made of cutouts with complicated structures, forming the cylindrical or conical insert in two parts has proven to be advantageous. In this case, the insert is divided, along its longitudinal axis, into two half-cylinders or half-cones, the half-cylinders or half-cones lying one upon the other by way of their section planes to form a cylinder or cone. The cutout is advantageously arranged in the region of at least one section plane of a half-cylinder or half-cone. Shaped elements, e.g. spikes or bores, which are arranged on both half-cylinders or half-cones serve, by way of interengagement, to secure the position of the half-cylinders or half-cones.

The half-cylinders or half-cones are easier to install if they are connected integrally to one another, and therefore in captive fashion, at one edge of their section planes. The connection can easily be achieved by a film hinge which is made during production of the half-cylinders and half-cones.

The tool which is necessary for producing the cutout can be formed more straightforwardly if the cutout which generates the washing-fluid jet is arranged in the region of a section plane of a half-cylinder or half-cone, and the section plane of the second half-cylinder or half-cone is designed as a sealing surface. This is advantageous, in particular, when the cutout is a fluidic structure which generates an oscillating washing-fluid jet.

The angle of inclination of the washing nozzle can be set particularly easily, for example as the washing-fluid jet is generated, if the insert or the washing nozzle is formed cylindrically or conically and has means which are accessible from outside the nozzle holder and are intended for the attachment of a turning tool. In the simplest case, the means for the attachment of a turning tool may be a slot which is arranged laterally on the insert and is intended for a screwdriver.

The invention allows numerous embodiments. In order to demonstrate its basic principle, a number of these are described hereinbelow and illustrated in the drawing, in which:

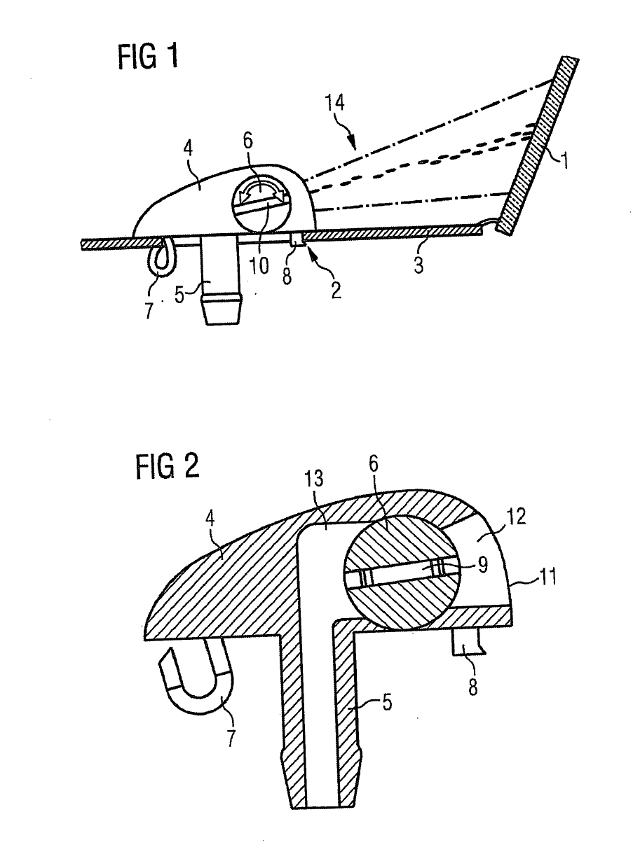

FIG. 1 shows a device according to the invention with a nozzle holder fixed in a cutout of a bodywork panel,

FIG. 2 shows a vastly enlarged sectional illustration of the device according to the invention from FIG. 1,

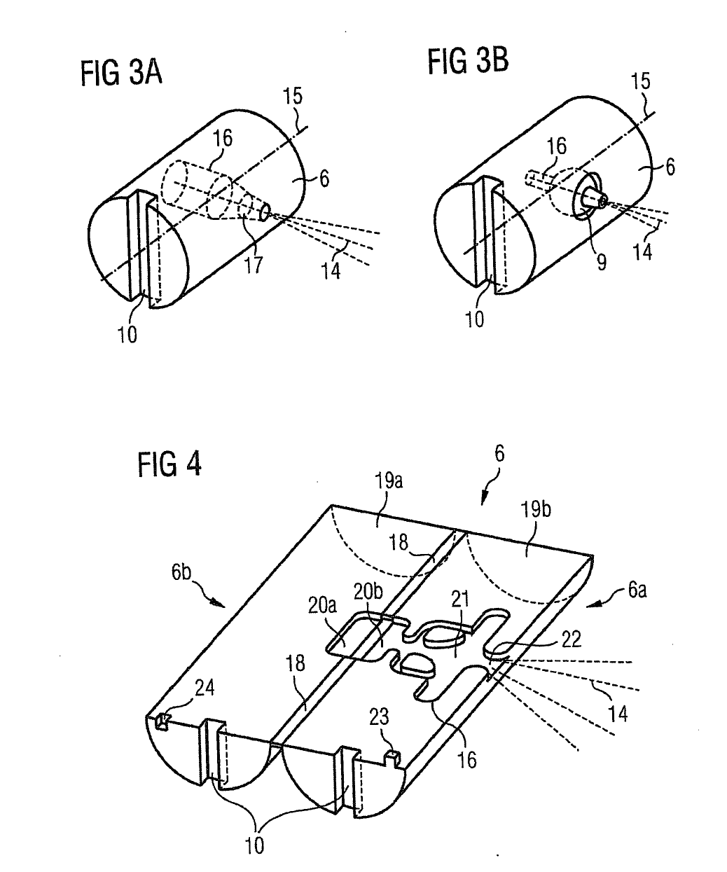

FIGS. 3a and b each show an insert of the device according to FIG. 1, and

FIG. 4 shows an insert according to FIG. 1 which is formed from two half-cylinders.

FIG. 1 shows a device which is intended for cleaning a window 1 of a motor vehicle and has a nozzle holder 4 arranged in a cutout 2 of a bodywork panel 3. The window 1 may also be a lens of a headlamp of a motor vehicle. The nozzle holder 4 is in mushroom form and has, as its stem, a connection stub 5 for the connection of a washing-fluid line (not illustrated). An insert 6 is arranged in the head region such that the longitudinal axis of this insert is oriented transversely in relation to the longitudinal axis of the vehicle. The underside of the head region has latching means 7, 8 designed as latching hooks and secures the nozzle holder 4 in a non-displaceable manner on the bodywork panel 3. The insert 6 serves for securing a washing nozzle 9 which is illustrated in FIG. 2. The insert 6 is mounted in the nozzle holder 4 such that it can be rotated about a horizontal axis, but cannot be displaced axially, and has a slot 10 provided for the attachment of a screwdriver. During rotation of the insert 6, it is possible to adjust an angle of inclination of a washing-fluid jet 14 which is generated by the washing nozzle 9 illustrated in FIG. 2. The limits of the adjustment range of the washing-fluid jet 14 are illustrated by chain-dotted lines in the drawing.

FIG. 2 shows the device from FIG. 1 in a vastly enlarged longitudinal section. It can be seen here that the washing nozzle 9 is designed as fluidic nozzle and is very small in comparison with the insert 6. The washing-fluid jet 14 of such fluidic nozzles is very sharp and oscillates in one plane. In the region where the washing nozzle 9 exits, the nozzle holder 4 has a large opening 11. The opening 11 allows a large adjustment range of the angle of inclination of the washing-fluid jet 14 which is generated by the washing nozzle 9, and it also delimits a border 12 which protects the washing nozzle 9 against weathering influences and relative wind. A chamber 13 is arranged in the nozzle holder 4 upstream of the washing nozzle 9, as seen in the direction of flow. The chamber 13 ensures a sufficient supply of washing fluid to the washing nozzle 9 for each angle of inclination.

FIG. 3a shows the insert 6 from FIG. 1 in a perspective illustration. The cylindrical insert 6 has, on one side, a slot 10 for purposes of rotation, in order thus to set the angle of inclination of the washing-fluid jet 14. A cutout 16 is arranged perpendicularly to the longitudinal axis 15 of the insert 6. The cutout 16 is a bore which tapers downstream in the direction of the window which is to be cleaned (not illustrated). The bore 16 tapers in a step-like manner in a region 17. The bore acts as a nozzle for generating the washing-fluid jet 14.

The insert 6 in FIG. 3b differs from the insert in FIG. 3, on the one hand, by way of its conical outer contour; on the other hand, the insert 6 has a cutout 16 into which is clipped a washing nozzle 9 designed as a point-jet nozzle.

The insert 6 which is illustrated in FIG. 4 comprises two half-cylinders 6a, 6b which are connected integrally to one another via a film hinge 18. By virtue of the two half-cylinders 6a, 6b being swung together, they lie one upon the other by way of their section planes 19a, 19b, thus forming the insert 6. The half-cylinders 6a, 6b each have an opening 20a, 20b, each of these openings being in connection with the chamber 13 in order to allow the washing fluid to flow through. In the section plane 19b of the half-cylinder 6b, the cutout 16 is designed, following the opening 20b, as a fluidic structure 21. As a result of the fluidic structure 21, the washing fluid which flows in via the openings 20a, 20b generates an oscillating washing-fluid jet 14 which leaves the insert 6, via the outlet opening 22, in the direction of the window (not illustrated). The section plane 19a of the half-cylinder 6a here forms the sealing surface for the purpose of sealing the fluidic structure 21. In order to secure the position of the half-cylinders 6a, 6b in the joined-together state, the half-cylinder 6b has a protrusion 23, which engages in a groove 24 of the half-cylinder 6a.

1. A device which arranged in a motor vehicle for cleaning a window or headlamp lens, comprising:
a washing nozzle retained by a nozzle holder,
means for adjusting an angle of inclination of the washing nozzle, the means for adjusting the angle of inclination of the washing nozzle being formed in relation to the nozzle holder, and
wherein the washing nozzle is fixed in an insert arranged in the nozzle holder, the insert retained in a rotatable manner and comprising a washing nozzle having a cutout which generates a washing-fluid jet the insert further being divided along a longitudinal axis into two substantial half-cylinders or half-cones, the half-cylinders or half-cones lying one upon the other by way of their section planes from the formation of a cylinder or cone, the half-cylinders or half-cones further being connected integrally to one another at one edge of their section planes such that they can be swung together to form a cylinder or cone.

2. (canceled)

3. The device according to claim 1, wherein the nozzle holder *fin the region of the washing nozzle, has a large opening in comparison with a diameter of a washing-fluid jet which can be generated by the washing nozzle.

4. The device according to claim 1, wherein the nozzle holder has a chamber which is arranged immediately upstream of the insert the washing nozzle, as seen in the direction of flow, and, in order to connect a washing-agent supply to the washing nozzle, is formed over the entire pivoting range thereof.

5. The device according to claim 1, wherein the nozzle holder is in mushroom form and, on the underside of its head region, has latching means which provided for connecting it to a bodywork panels.

6. The device according to claim 1, wherein the insert or the washing nozzle is formed cylindrically or conically and has means which are accessible from outside the nozzle holder and are intended for the attachment of a turning tool.

7. The device according to claim 1, wherein the cutout which generates the washing-fluid jet is a bore.

8. (canceled)

9. The device according to claim 7, wherein the bore tapers continuously or in a step-like manner downstream.

10. The device according to claim 1, wherein the connection of the half-cylinder or half cone has a film hinge.

11. (canceled)

12. The device according to claim 10, wherein the cutout which generates the washing-fluid jet is arranged in the region of at least one section plane of a half-cylinder or half-cone.

13. The device according to claim 10, wherein the cutout which generates the washing-fluid jet is arranged in the region of a section plane of a half-cylinder or half-cone, and in that the section planes of the second half-cylinder or half-cone is designed as a sealing surface.

14. The device according to claim 1, wherein the cutout is a fluidic structure which generates an oscillating washing-fluid jet.

15. The device according to claim 1, wherein shaped elements, preferably spikes, protrusions, grooves, bores, are arranged on the half-cylinders or half-cones.
